(19) United States
(12) Patent Application Publication
(10) Pub. No.: US 2007/0294909 A1
(43) Pub. Date: Dec. 27, 2007

(54) Noiseless hair dryer

(76) Inventors: Frank F. Abdi, Anaheim, CA (US); Christos C. Chamis, Westlake, OH (US)

Correspondence Address: TERRELL P. LEWIS;UNIT #8, 343 PALOS VERDES BOULEVARD, REDONDO BEACH, CA, 90277, US

(21) Appl. No.: 11/474,875

(22) Filed: Jun. 26, 2006

(51) Int. Cl. A45D 20/12; H02K 5/24

(52) U.S. Cl. 34/97; 181/202; 34/96

(57) ABSTRACT

The present invention is a noiseless hair dryer that includes first and second cylindrical bodies extending along an axis, each of the bodies having an intake end and an exhaust end, and the two bodies being arranged in such a manner that the second cylindrical body is disposed within, and carried concentrically by, the first cylindrical body. The second cylindrical body defines a first air flow channel, and the volume between the inner surface of the first cylindrical body and the outer surface of the second cylindrical body defines a second air flow channel. A substantially noiseless fan is mounted at the intake end of the first cylindrical body, and is driven in rotation by a bearing cage, attached to, and disposed circumferentially about, the radially outer surfaces of the fan. A power supply provides electrical energy to drive the outer race of the bearing cage in rotation about the axis. A heating element, preferably provided as a helical wire, is disposed in the volume between the first and second cylinders for heating air flowing in the first air flow channel, such that when the air passing through the first and second cylindrical bodies exits through the exhaust end of the hair dryer, the air streams mix to cause inverted exhaust velocity, and thereby a substantial reduction in noise.

### BACKGROUND OF THE INVENTION

1. Field of the Invention

The present invention relates to electric hair dryers and blowers, and more particularly to a portable hand-held hair dryer having a light-weight housing containing an electric power source, a fan or blower, and a heating element.

Even more particularly, the hair dryer of the present invention concerns a method and apparatus for substantially eliminating noise-producing energy associated with operation of the dryer motor and with the air flowing from within the dryer out to the ambient through the exhaust.

Still more particularly, the hair dryer of the present invention includes a housing to which is mounted an “inverted” intake fan, that is a fan having blades secured to a central ring and driven in rotation about a longitudinal housing axis by driving apparatus located at, and secured to, the radial extremities of the blades. The driving apparatus is preferably a noiseless bearing assembly arranged circumferentially about the central ring and the blades. A first or “outer” flow path is defined between the inner surface of the dryer housing and the outer surface of a second housing concentrically supported within the dryer housing. The second housing defines a second or “inner” flow path that is concentrically disposed relative to the first flow path of the dryer housing. The first and second flow paths discharge into the ambient through the exhaust. The air flow through the first flow path between the dryer housing and the second housing is heated by a heating element, and when the air flowing in the second flow path reaches the exhaust, it is drawn outwardly and into contact with the heated air flowing in the first flow path. The colder air upon expansion, releases energy, and when it mixes with the hotter air, noise associated with turbulence of the mixing air flows is effectively eliminated.

2. Description of the Related Art

Hand-held hair dryers are typically one of three types: a pistol grip dryer, a styling-dryer, and an axial flow dryer. Generally, the pistol grip dryer has a pistol type handle, a centrifugal fan, and an air discharge tube generally perpendicular to the handle. The styling-dryer typically has a blower shaped as a cylinder or squirrel cage with vanes positioned parallel to the axis of rotation, an adjacent discharge duct having length and width about the same as that of the blower, and a handle also parallel to the blower axis. The axial-flow dryer typically includes a generally straight tubular housing, of which one end serves as a handle, the opposite end serves as a discharge duct, and a fan is situated in the tube near its mid-point for forcing air, entering at side vents to flow through the tube to exit its discharge end.

Each of these devices has specific structure for serving specific purposes. For example, the pistol grip dryer is used by professional hair stylists, and has a gun barrel type discharge duct for providing an accurately directed and powerful air flow as the stylist points the duct at the customer's hair. The styling-dryer type allows the user to dry her or his own hair because the handle and blower portions comprise a single elongated construction, and thus the handle can be held vertically while the air discharge portion is oriented to direct air at right angles relative to the handle. In the axial or through-flow dryer, a brush is attached to the central core which extends coaxially with the tube's handle and discharge duct, but has transversely extending bristles through which the heated air from the blower flows.

Each of these hair dryers typically comprise a rigid housing, a power source, a blower, and a heater, all disposed in predetermined locations. The blower, or the power source and blower, emit loud noises. In addition, the air that is forced through the body of the hair dryer to the discharge end encounters various abutments and protrusions which result in turbulent flow thus creating a great deal of noise. Generally, the level of noise reaches such a level that it is difficult to carry on a conversation while these hair dryers are in operation.

Various mechanisms have been employed in an attempt to reduce noise of such hair dryers, including sound baffle or damper devices in the dryer intake or exhaust conduit, sound absorbing materials or resonator chambers within the dryer housing, and laminar flow inducing structures on the inner wall surfaces of the dryer housing. Examples of these features can be found in the hair dryers disclosed in U.S. Pat. No. 6,755,278 to Hunh et al., U.S. Pat. No. 4,799,2887 to Belanger et al., and U.S. Pat. No. 4,223,419 to Sato et al. U.S. Pat. No. 4,767,914 to Glucksman teaches a hair dryer having inner and outer air flows of different temperatures that are caused to mix at an exhaust end of the hair dryer.

Also known is U.S. Pat. No. 6,393,831 to Chamis et al. that pertains to a turbojet engine structure. The turbojet of this patent comprises a drum-like member that is mounted for rotation on bearings located circumferentially about the outer wall of the drum-like member. The engine also includes two concentrically arranged flow paths.

Against this background, applicants have designed a hair dryer having a construction that affords virtually noiseless operation. None of the previously known hair dryers can provide a powerful air flow for drying hair without creating a high level of noise either as a result of operation of the motor or as a result of the air rushing from the exhaust.

### OBJECTS AND SUMMARY OF THE PRESENT INVENTION

It is therefore a principal aspect of the present invention to provide a virtually noiseless hair dryer. This is accomplished by using a fan not driven by the traditional hair dryer motor, and by employing principles of thermodynamics and fluid dynamics at the exhaust.

Another aspect of the present invention is to provide a hair dryer that is simple in construction in that it combines, in an axial arrangement, a single conical body housing a fan, two concentric air conveying channels, a heating element, and an air-mixing exhaust.

Yet another aspect of the present invention is to provide a hair dryer configuration that produces an unexpected result at the exhaust that yields a significant reduction in noise.

Still another aspect of the invention is to provide a greatly increased mixing capability at the exhaust portion of the dryer housing so that noise-producing energy associated with the mixing air flows is absorbed and any resulting noise is substantially eliminated.

Still another aspect of the present invention is to provide a hair dryer in a housing having a power source, a fan and a heated air flow that cooperate to produce a powerful flow of heated air while virtually eliminating any noise that interferes with normal conversation or is harmful to the human ear.

In the hair dryer of the present invention, the intake air is conveyed through an inner channel concentrically arranged within and supported by an outer channel, where the air flowing in the outer channel is heated, and the two thermally distinct air flows are caused to be mixed together at the exhaust, such that as a result of the inner cooler flow expanding upon contact with the outer hotter flow, noise energy typically created at exhausts in conventional hair dryers and associated with noise is eliminated.

Further, in the hair dryer of the present invention, the power source has no moving parts, and the bearing assembly supporting the fan construction affords a nearly noiseless operation.

### BRIEF DESCRIPTION OF THE DRAWINGS

For a more complete understanding of the present invention, the reader is referred to the following detailed description section, which should be read in conjunction with the accompanying drawings, in which:

FIG. 1 is a perspective view of the body of the hair dryer of the present invention, showing a handle attachment element H mounted longitudinally to an exterior surface of the hair dryer body;

FIG. 2 is an end view of the intake end of the hair dryer body shown in FIG. 1; and

FIG. 3 is a cross sectional view of the hair dryer body shown in FIG. 1.

### DETAILED DESCRIPTION OF THE INVENTION

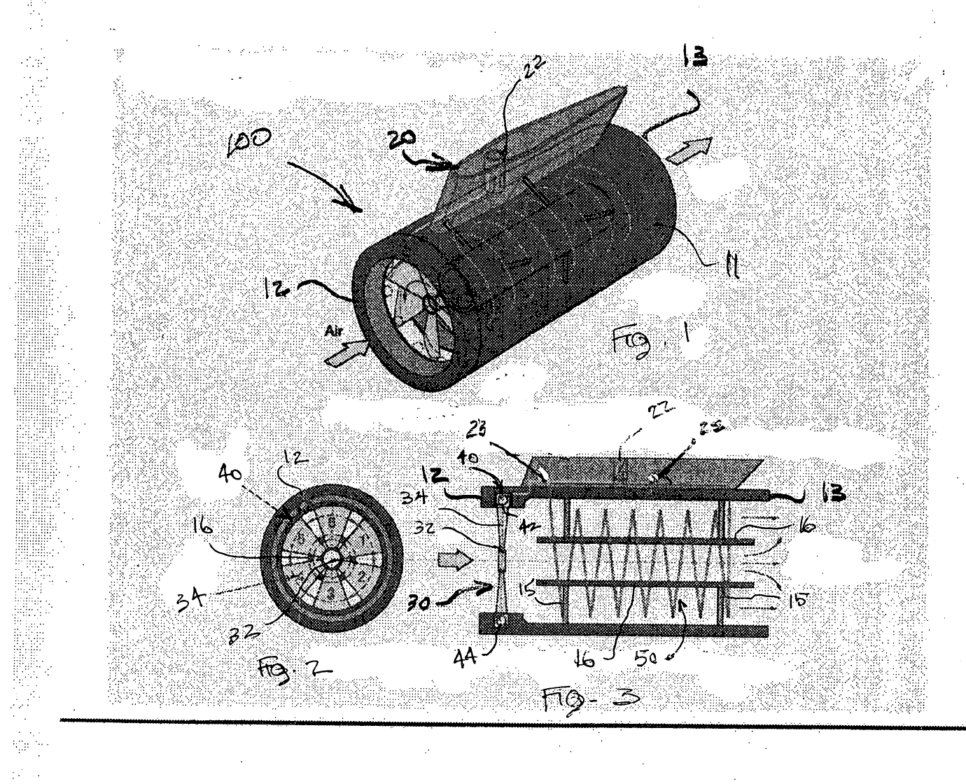

Referring now to FIGS. 1-3 of the drawings, which correspond to the following detailed description and in the drawings, and in which like numbers refer to like parts, there is shown the body 11 of the hair dryer 100 which has a longitudinal axis along which is an intake end 12 and an exhaust end 13. Positioned along a longitudinal region of the exterior of the body 11 is an axially extending housing 20 in which is located a power supply (shown generally at 22) and electrical conductors 23 that connect various components located inside the body 11 with the power supply 22.

Disposed proximate the intake end of the hair dryer 10 is an intake fan 30, that comprises a central circular hollow hub 32 configured as a ring, and a plurality of fan blades 34 that extend radially from the hub 32 to the inner race 42 of a bearing cage 40 disposed in a circumferential recess 14 of the body 11. The bearing cage 40 also comprises an outer race 44 to which is engaged with the inner race 42 of the bearing cage, and which is further electrically coupled with the power supply 22 via conductors 23. The inner race 42 is driven in circumferential rotation about the longitudinal axis relative to the outer race 44 via power delivered from the power supply 22 through the conductors 23. The inner and outer races of the bearing cage 40 are cooperatively supported in such a manner that they move relative to one another in noiseless operation. In this way, there is no noise emanating from operation of the intake fan of the present invention which contrasts with operation of known intake fans that interfere with the noise level of normal conversation between human beings.

FIG. 2 depicts is an end view of the interior of the hair dryer 100 as seen looking into the intake end, and along the longitudinal axis, of the body 11 of the hair dryer. Six blades are shown in FIG. 2, but it is to be understood that a fan rotor can be chosen wherein the number of blades is different; the principal requirement is to provide a predetermined volume and speed of air moving through the body of the hair dryer, and this can be accomplished by choosing the number of blades, their pitch and their length.

FIG. 3, which specifically depicts a cross-sectional view through the body 11 of the hair dryer 100 along the longitudinal axis, shows the body 11 including inwardly directed wall members 15 extending substantially normal to the inner surface of the body 11. The wall members 15 are radially directed and extend inwardly a distance equal to about ⅓ of the diameter of the body 11, where they intersect with, and are attached to, the outer surface of a conical body 16 having a length at least ¾ the length of the body 11. The wall members 15, which can be slender rod-like elements or pie-piece shaped segments of limited arcuate extent, support the conical body 16 substantially concentrically within the body 11. The conical body 16 defines a first, inner, flow path for the intake air, while the spaces between the outer surface of the conical body 16 and the inner surface of the body 11 define a second, outer, flow path for the intake air.

Disposed about the conical body 16 in the second, outer, flow path is a helical heating element 50, comprised preferably of a helical length of wire. The heating element 50 is connected via conductors 23 to the power source 22. The heating element, when energized, heats up and in turn acts upon and heats the intake air flowing in the second, outer, flow path.

When the intake air exits the inner and outer flow paths at the exhaust end of the body 11, the unheated colder air emanating from the exhaust end of the inner flow path expands as it is drawn outward of the conical body 16 and into contact with the heated air emanating from the outer flow path. In so doing, noise which typically is associated with the turbulence of the exiting cold air mixing with the hotter air surrounding it is cancelled by the loss of energy from the expanding cold air as the latter mixes with the encircling hot air emanating from the outer flow path.

Although the present invention has been described herein with respect to a preferred embodiment thereof, the foregoing description is intended to be illustrative, and not restrictive. Those skilled in the art will realize that many modifications of the preferred embodiment could be made which would be operable. All such modifications which are within the scope of the claims are intended to be within the scope and spirit of the present invention.

What we claim is:

1. A hair dryer, comprising:
first and second cylindrical bodies extending along an axis, each said body having an intake end and an exhaust end, said second cylindrical body being disposed within, and carried concentrically by, the first cylindrical body,
a substantially noiseless fan assembly disposed at said intake end of said first cylindrical body,
the volume between the inner surface of the first body and the outer surface of the second body defining a first air flow channel for air drawn into the intake end by the fan assembly,
said second cylindrical body defining a second air flow channel for air drawn into the intake end by the fan assembly,
means, carried by said first body, for powering fan blades of said fan assembly in rotation about said axis, and
heating means, disposed in the first air flow channel for heating air flowing therein,
the fan blades acting to draw air through the first and second conical bodies to the exhaust end where the air flows mix so as to cause a substantial reduction in noise.

2. The hair dryer of claim 1, wherein said means for driving said fan in rotation about said axis comprises power supply means carried on said first cylindrical body and conductors electrically coupled between said power supply means and said fan.

3. The hair dryer of claim 1, wherein said heating means comprises a heatable wire coil extending along, and helically disposed about, substantially the entire length of said second cylindrical body.

4. The hair dryer of claim 1, wherein said noiseless fan comprises an open ring having blades extending radially therefrom, said blades being supported to the hair dryer body adjacent the intake end of the body.

5. The hair dryer of claim 4, and further including a bearing cage comprising an inner race and an outer race, and the portions of the blades farthest from the open ring being secured to the inner race of the bearing cage.

6. The hair dryer of claim 3, wherein said heating coil comprises a length of copper wire having first and second ends, said ends being coupled to a power supply mounted to said body.

7. The hair dryer of claim 1, wherein said cylindrical bodies are secured to one another.

8. The hair dryer of claim 7, and further including strut elements connecting the inner cylinder with the outer cylinder.

9. The hair dryer of claim 8, wherein said strut elements comprise radially extending rod-shaped members.

10. The hair dryer of claim 8, wherein said strut elements maintain the inner cylinder longitudinally and rotationally fixed relative to the outer cylinder.

11. A substantially noiseless hair dryer, comprising:
a housing member having an air intake end and an air exhaust end,
a first air flow path leading from the intake end of the housing to the exhaust end of the housing,
a second air flow path leading from the intake end of the housing to the exhaust end of the housing, said second air flow path being physically separated from, and arranged within, the first air flow path,
a fan assembly at said intake end of said housing, and a power means for powering said fan assembly, and
noise-reducing air mixing means at the exhaust end of the housing.

12. The noiseless hair dryer of claim 11, and further comprising a heating element in said first flow path for heating air flowing therethrough.

13. The noiseless hair dryer of claim 11, wherein said air mixing means at the exhaust end of said housing allows air emanating from said second flow path to flow into impingement with air emanating from said first flow path whereupon energy associated with turbulence in the air exiting from said second flow path is dissipated when the two air flows mix.

14. The noiseless hair dryer of claim 13, and further including heating means, disposed in the first flow path for heating air flowing therethrough.
